(19) United States
(12) Patent Application Publication
(10) Pub. No.: US 2015/0179180 A1
(43) Pub. Date: Jun. 25, 2015

(54) METHOD AND DEVICE FOR PROCESSING AUDIO SIGNAL

(71) Applicant: INTELLECTUAL DISCOVERY CO., LTD., Seoul (KR)

(72) Inventors: Hyun Oh Oh, Seongnam-si (KR); Jeongook Song, Seoul (KR)

(73) Assignee: INTELLECTUAL DISCOVERY CO., LTD., Seoul (KR)

(21) Appl. No.: 14/414,934

(22) PCT Filed: Jul. 26, 2013
(86) PCT No.: PCT/KR2013/006729

§ 371 Date: Jan. 15, 2015

(30) Foreign Application Priority Data
Jul. 31, 2012 (KR) 10-2012-0084206

(51) Int. Cl. G10L 19/008; H04R 5/04

(52) U.S. Cl. CPC G10L 19/008; H04R 5/04

(57) ABSTRACT

The present invention relates to a method and device for processing an audio signal, and the method comprises the steps of: receiving a down-mix (DMX) signal; receiving information on an inter-channel phase difference (IPD) corresponding to a phase difference between a first phase channel and a second phase channel; receiving an inter-channel level difference corresponding to a level difference between the first phase channel and the second phase channel; determining the definition of a first weight and a second weight on the basis of the inter-channel level difference; calculating the first weight and the second weight by using the IPD according to the determined definition; generating information on an overall phase difference (OPD) corresponding to a phase difference between the first phase channel and the DMX signal on the basis of the first weight and the second weight.

### TECHNICAL FIELD

The present invention relates generally to an audio signal processing method and apparatus capable of processing audio signals and, more particularly, to an audio signal processing method and device that are capable of encoding or decoding audio signals.

### BACKGROUND ART

Generally, with the large-scale trend of video images, there is a requirement for providing an immersive sense of audio to a listener as if audio surrounds the listener. In order to improve the presence or immersive surround sound envelopment, the number of audio channels may be larger than 2 channels or 5.1 channels. Audio signals corresponding to the number of channels (e.g., 22.2 channels) ranging to a maximum of several tens may be processed.

### DISCLOSURE

### Technical Problem

A plurality of channel signals ranging to a maximum of several tens of signals may be downmixed by an encoder and such a downmix signal may be transmitted to a decoder. The downmix signal must be unmixed by the decoder so that they are approximate to original channel signals.

### Technical Solution

The present invention has been made keeping in mind the above problems, and an object of the present invention is to provide an audio signal processing method and device, which can upmix one or more channel signals of a downmix signal into two or more channel signals by using an upmixing parameter (e.g., an inter-channel phase difference) received from an encoder.

Another object of the present invention is to provide an audio signal processing method and device, which is configured such that, when an inter-channel phase difference (IPD) corresponding to a phase difference between a first phase channel and a second phase channel is received from an encoder, an overall phase difference (OPD) corresponding to a phase difference between the first phase channel and a downmix signal can be generated using the IPD.

A further object of the present invention is to provide an audio signal processing method and device, which can apply weights to the generation of an overall phase difference (OPD) from an inter-channel phase difference (IPD) in order to prevent an error from occurring as a phase difference between a first phase channel (e.g., left channel) and a second phase channel (e.g., right channel) is approximate to 180.

Yet another object of the present invention is to provide an audio signal processing method and device, which can vary the definition of a first weight to be applied to a first phase channel (e.g., left channel) depending on the level of the first phase channel, upon applying weights.

Still another object of the present invention is to provide an audio signal processing method and device, which selectively apply an upmixing parameter and an upmix residual signal to a downmix signal when the upmixing parameter and the upmix residual signal are received from an encoder, thus implementing scalable audio upmixing by differently setting the number of channels of output signals.

In accordance with an aspect of the present invention to accomplish the above object, there is provided an audio signal processing method, including receiving a downmix signal; receiving inter-channel phase difference (IPD) information corresponding to a phase difference between a first phase channel and a second phase channel; receiving a channel level difference (CLD) corresponding to a level difference between the first phase channel and the second phase channel; determining a definition of a first weight and a second weight based on the CLD; calculating the first weight and the second weight using the IPD based on the determined definition; and generating overall phase difference (OPD) information corresponding to a phase difference between the first phase channel and the downmix signal, based on the first weight and the second weight.

In accordance with the present invention, the audio signal processing method may further include generating the first phase channel and the second phase channel using the overall phase difference (OPD) information and the downmix signal.

In accordance with the present invention, the definition includes a first definition and a second definition, wherein when a level value of the first phase channel is greater than that of the second phase channel depending on the IPD, the first weight may be greater than the second weight, whereas when the level value of the second phase channel is greater than that of the first phase channel depending on the IPD, the second weight may be greater than the first weight.

In accordance with another aspect of the present invention, there is provided an audio signal processing device, including a demultiplexing unit for receiving a downmix signal, receiving an inter-channel phase difference (IPD) corresponding to a phase difference between a first phase channel and a second phase channel, and receiving a channel level difference (CLD) corresponding to a level difference between the first phase channel and the second phase channel; a weight definition determination unit for determining a definition of a first weight and a second weight based on the channel level difference; a weight generation unit for calculating the first weight and the second weight using the IPD based on the definition; and an overall phase difference (OPD) generation unit for generating OPD information corresponding to a phase difference between the first phase channel and the downmix signal, based on the first weight and the second weight.

In accordance with the present invention, the apparatus may further include an OPD application unit for generating the first phase channel and the second phase channel using the OPD and the downmix signal.

In accordance with the present invention, the definition includes a first definition and a second definition, wherein when a level value of the first phase channel is greater than that of the second phase channel depending on the IPD, the first weight may be greater than the second weight, whereas when the level value of the second phase channel is greater than that of the first phase channel depending on the IPD, the second weight may be greater than the first weight.

In accordance with a further aspect of the present invention, there is provided an audio signal processing method, including receiving a downmix signal; receiving an inter-channel phase difference (IPD) corresponding to a phase difference between a first phase channel and a second phase channel; receiving a channel level difference corresponding to a level difference between the first phase channel and the second phase channel; calculating a first weight to be applied to the first phase channel and a second weight to be applied to the second phase channel; determining a definition of a sum of the first phase channel and the downmix signal based on the channel level difference; and generating overall phase difference (OPD) information corresponding to a phase difference between the first phase channel and the downmix signal, based on the first weight and the second weight depending on the sum definition.

In accordance with the present invention, the method may further include generating the first phase channel and the second phase channel using the OPD and the downmix signal.

In accordance with the present invention, the sum definition may include a first sum definition and a second sum definition, wherein when a level value of the first phase channel is greater than that of the second phase channel depending on the IPD, the first weight may be greater than the second weight in the first sum definition, whereas when the level value of the second phase channel is greater than that of the first phase channel depending on the IPD, the second weight may be greater than the first weight in the second sum definition.

In accordance with yet another aspect of the present invention, there is provided an audio signal processing method, including receiving a downmix signal; receiving one or more of an upmixing parameter and an upmix residual signal; when the upmixing parameter is received, applying the upmixing parameter to the downmix signal, thus generating M parametric output channels; and when both the upmixing parameter and the upmix residual signal are received, applying the upmixing parameter and the upmix residual signal to the downmix signal, thus generating N discrete output channels.

### Advantageous Effects

The present invention provides the following effects and advantages.

First, since a downmix signal may be upmixed into a multichannel signal of 5.1 or more channels using an upmixing parameter, and thus bit efficiency may be improved compared to a case where the multichannel signal is encoded without change.

Second, since speaker setting is a mono or stereo format, there is no need to downmix a reconstructed multichannel signal after a multichannel signal of 5.1 or more channels has been reconstructed, when the downmix signal may be decoded without requiring an upmixing procedure, thus reducing a computational load and complexity.

Third, since an overall phase difference (OPD) may be calculated based on an inter-channel phase difference (IPD), there is no need to separately transmit the OPD, thus reducing the number of bits.

Fourth, upon generating an OPD required for upmixing, weights are applied, and thus destructive interference effect occurring when a phase difference between a first phase channel and a second phase channel is approximate to 180° may be reduced.

Fifth, a phenomenon in which, if a large weight is applied to a case where the level of a first phase channel is low, distortion is rather increased may be prevented.

Sixth, a decoding unit has a scalable structure, so that the decoding levels of bitstreams are differently set according to the speaker setup of individual devices, thus not only increasing bit efficiency, but also decreasing a computational load and complexity.

### DESCRIPTION OF DRAWINGS

FIG. 1 is a diagram showing viewing angles depending on the sizes of an image (UHDTV and HDTV) at the same viewing distance;

FIG. 2 is a diagram showing the arrangement of 22.2 channel speakers as an example of a multichannel environment;

FIG. 3 is a diagram showing a procedure for downmixing a multichannel signal;

FIG. 4 is a diagram showing the configuration of a decoder according to an embodiment of the present invention;

FIG. 5 illustrates a first embodiment of the output channel generation unit 120 of FIG. 4;

FIG. 6 illustrates a second embodiment of the output channel generation unit 120 of FIG. 4;

FIG. 7 illustrates a third embodiment of the output channel generation unit 120 of FIG. 4;

FIG. 8 is a detailed configuration diagram showing an embodiment of the upmixing unit 122 of FIGS. 5 to 7;

FIG. 9 is a diagram showing a distortion phenomenon caused by a phase difference;

FIG. 10 is a diagram showing the configuration of an encoder and a decoder according to another embodiment of the present invention; and

FIG. 11 is a schematic configuration diagram of a product in which an audio signal processing device according to an embodiment of the present invention is implemented.

### BEST MODE

Hereinafter, preferred embodiments of the present invention will be described in detail with reference to the attached drawings. Prior to the following detailed description of the present invention, it should be noted that the terms and words used in the specification and the claims should not be construed as being limited to ordinary meanings or dictionary definitions, and the present invention should be understood to have meanings and concepts coping with the technical spirit of the present invention based on the principle that an inventor can appropriately define the concepts of terms in order to best describe his or her invention. Therefore, the embodiments described in the specification and the configurations illustrated in the drawings are merely preferred examples and do not exhaustively present the technical spirit of the present invention. Accordingly, it should be appreciated that there may be various equivalents and modifications that can replace the embodiments and the configurations at the time at which the present application is filed.

The terms in the present invention may be construed based on the following criteria, and even terms, not described in the present specification, may be construed according to the following gist. Coding may be construed as encoding or decoding according to the circumstances, and information is a term encompassing values, parameters, coefficients, elements, etc. and may be differently construed depending on the circumstances, but the present invention is not limited thereto.

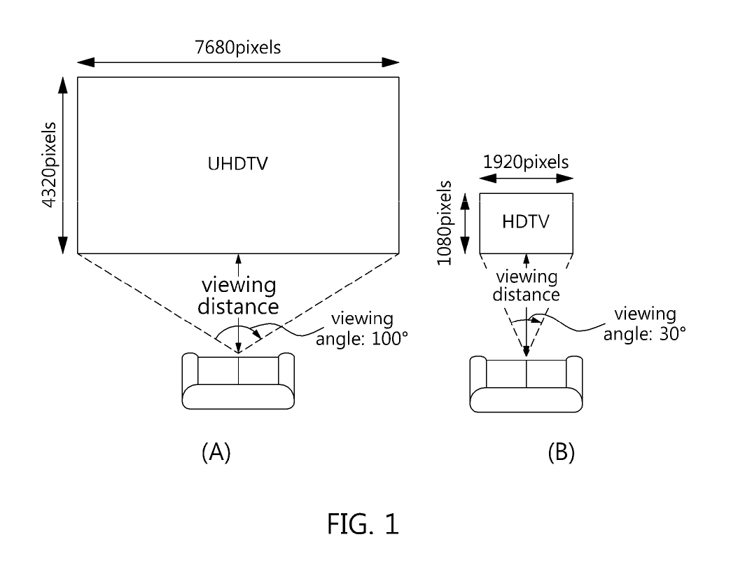

FIG. 1 is a diagram showing viewing angles depending on the sizes (e.g., ultra-high definition TV (UHDTV) and high definition TV (HDTV)) of an image at the same viewing distance. With the development of production technology of displays and an increase in consumer demands, the size of an image is on an increasing trend. As shown in FIG. 1, a UHDTV image (7680*4320 pixel image) is about 16 times larger than a HDTV image (1920*1080 pixel image). When an HDTV is installed on the wall surface of a living room and a viewer is sitting on a sofa at a predetermined viewing distance, the viewing angle may be 30°. However, when a UHDTV is installed at the same viewing distance, the viewing angle reaches about 100°. In this way, when a high-quality and high-resolution large screen is installed, it is preferable to provide sound with high realism and high presence in conformity with large-scale content. To provide such an environment that a viewer feels as if he or she were present in a field, it may be insufficient to provide only one or two surround channel speakers. Therefore, a multichannel audio environment having a larger number of speakers and channels may be required.

As described above, in addition to a home theater environment, a personal 3D TV, a smart phone TV, a 22.2 channel audio program, a vehicle, a 3D video, a telepresence room, cloud-based gaming, etc. may be present.

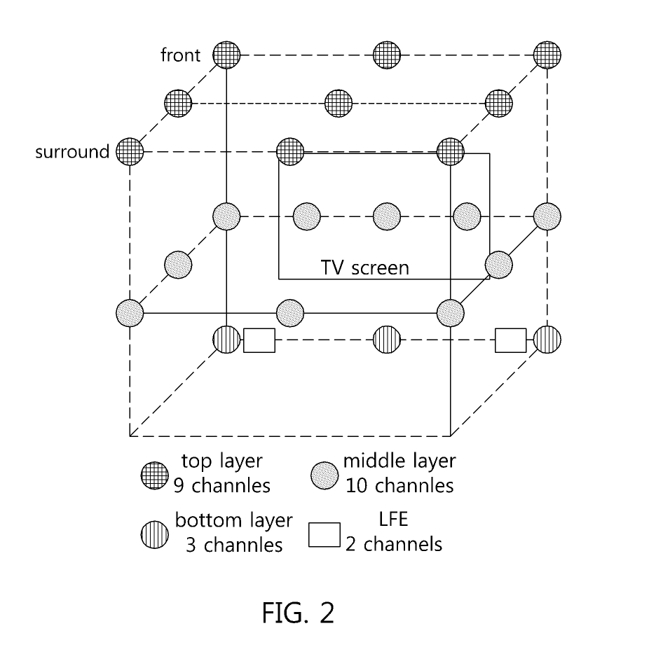

FIG. 2 is a diagram showing an example of a multichannel environment, wherein the arrangement of 22.2 channel (ch) speakers is illustrated. The 22.2 channels may be an example of a multichannel environment for improving sound field effects, and the present invention is not limited to the specific number of channels or the specific arrangement of speakers. Referring to FIG. 2, a total of 9 channels may be provided to a top layer. That is, it can be seen that a total of 9 speakers are arranged in such a way that 3 speakers are arranged in a top front position, 3 speakers are arranged in a top side/center positions, and three speakers are arranged in a top back position. On a middle layer, 5 speakers may be arranged in a front position, 2 speakers are arranged in side positions, and 3 speakers may be arranged in a back position. Among the 5 speakers in the front position, 3 center speakers may be included in a TV screen. On a bottom layer, 3 channels and 2 low-frequency effects (LFE) channels may be installed in a bottom front position.

In this way, upon transmitting and reproducing a multichannel signal ranging to a maximum of several tens of channels, a high computational load may be required. Further, in consideration of a communication environment or the like, high compressibility may be required. In addition, in typical homes, a multichannel (e.g., 22.2 ch) speaker environment is not frequently provided, and many listeners have 2 ch or 5.1 ch setup. Thus, in a case where signals to be transmitted in common to all users are sent after have been respectively encoded into a multichannel signal, communication inefficiency occurs when the multichannel signal must be converted back into 2 ch and 5.1 ch signals. In addition, 22.2 ch Pulse Code Modulation (PCM) signals must be stored, and thus memory management may be inefficiently performed.

Therefore, after a downmixing procedure (M-N downmix) that is a procedure of reducing the number of channels to the smaller number of channels (N channels, the number of output channels) is performed rather than respectively encoding and transmitting channels of a multichannel signal (a total of M channels, the number of input channels), a downmix signal may be transmitted to a decoder. The decoder may receive the downmix signal and reproduce the downmix signal without change, or may generate a number of channel signals, which is identical to the number of channels of original signals, from the downmix signal using information extracted in the downmixing procedure.

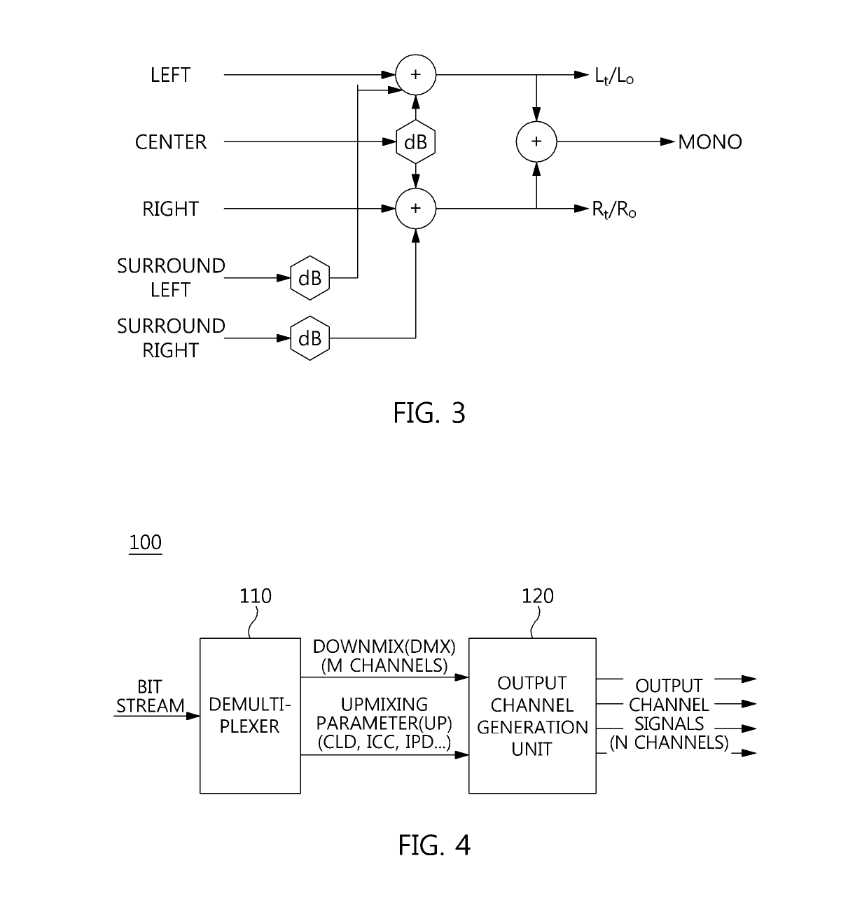

FIG. 3 is a diagram showing a procedure for downmixing a multichannel signal. The multichannel signal may be downmixed according to a tree structure defined by an encoder. A downmixing procedure will be described using a case where a 5.1 ch signal is a multichannel signal as an example. However, the present invention is not limited to a specific tree structure or the specific number of input channels, and a multichannel signal may be a 22.2 ch signal. Further, although the channels (N channels) of a downmix signal have been described using an example of a mono or stereo signal in FIG. 3, it should be noted that, as long as the number N of channels is less than the number M of input channels, channels may be freely used in any case (5.1 ch or the like).

Referring to FIG. 3, a left channel, a right channel, a center channel, a surround left channel, and a surround right channel may become a multichannel configuration or a part thereof. The center channel is scaled and is then individually distributed to the left channel and the right channel. Additionally, when the surround left channel and the surround right channel are present, they may be scaled and then be included in the left channel and the right channel, respectively. As a result, a summed left channel (Lt/Lo) and a summed right channel (Rt/Ro) may be generated, and they may be combined with each other to generate a mono signal.

Meanwhile, in such a downmixing procedure, a problem may arise in that the quality of signals is deteriorated due to the effect of destructive interference between antiphase signals. In detail, when downmixing is performed in such a way as to simply obtain a sum of neighboring channels, there is a high probability that identical signals having different phases may be consequently summed. In this procedure, an amplification effect or an attenuation effect occurs on some signals, and as a result, correlation distortion may occur. Further, when downmixing is performed by simply adding channels on a top layer or a bottom layer to a middle layer, the implementation of a desired sound scene may be actually impossible.

In this way, signals downmixed into a mono or stereo signal or the like may be upmixed into a multichannel signal of 5.1 channels or more by a decoder. As described above, since sound quality may be deteriorated due to the destructive interference effect in the downmixing procedure, compensation for such deterioration may be processed in an upmixing procedure. Such a procedure will be described with reference to FIG. 4.

FIG. 4 is a diagram showing the configuration of a decoder according to an embodiment of the present invention. Referring to FIG. 4, the decoder according to the embodiment of the present invention includes a demultiplexer 110 and an output channel generation unit 120. The demultiplexer 110 receives an audio bitstream from an encoder, and extracts a downmix signal DMX and an upmixing parameter UP from the bitstream. Of course, the downmix signal and the upmixing parameter may be received through separate individual audio signal bitstreams rather than a single bitstream.

The output channel generation unit 120 may generate a multichannel signal (corresponding to N channels) by applying the upmixing parameter UP to the received downmix signal DMX. As described above, the multichannel signal is a signal having more channels than M channels of the downmix signal and may be a 5.1-channel (ch) or 22.2-channel (ch) signal. The number N of channels of the multichannel signal may be identical to the number of input channels of the encoder, but may not be identical thereto depending on the circumstances.

Here, the upmixing parameter UP may include a spatial parameter and inter-channel phase difference (IPD) information. The spatial parameter may include channel level differences (CLD), and may further include inter-channel coherences (correlations) (ICC). When two channels (first input channel and second input channel) are downmixed into a single channel (first output channel) through a single One-To-Two (OTT) box, a channel level difference (CLD) is a level difference between the first input channel and the second input channel, and an ICC is a correlation between the first and second input channels.

Meanwhile, inter-channel phase difference (IPD) information may be an IPD itself, or a value obtained by quantizing or encoding the IPD. The demultiplexer 110 acquires an IPD from the received IPD information. Here, the IPD corresponds to a difference between the phases of the first input channel and the second input channel. The first input channel and the second input channel may also be referred to as a first phase channel and a second phase channel.

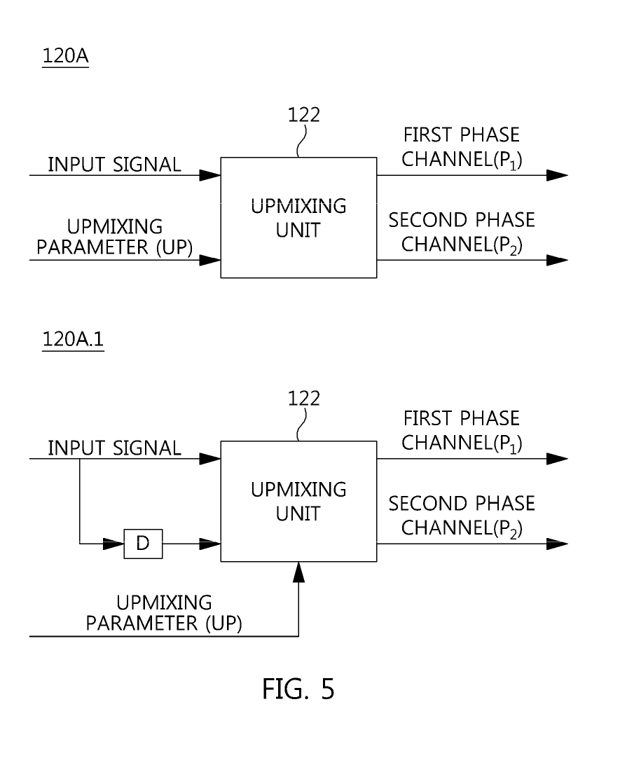

In this way, the output channel generation unit 120 may generate output channel signals corresponding to multiple channels by applying the upmixing parameter UP to the downmix signal through one or more upmixing units. Various embodiments 120A, 120B, and 120C of the output channel generation unit 120 will be described below with reference to FIGS. 5 to 7.

FIGS. 5 to 7 illustrate first embodiment 120A to third embodiment 120B of the output channel generation unit 120 of FIG. 4. First, referring to FIG. 5, the output channel generation unit 120A according to a first embodiment includes a single upmixing unit 122. The upmixing unit 122 generates a first phase channel P1 and a second phase channel P2 by applying an upmixing parameter UP to a single input signal. Here, the input signal may be a received downmix signal itself or may be a single channel signal included in a downmix signal. Here, the upmixing parameter UP may include an inter-channel phase difference (IPD) and a channel level difference (CLD). Meanwhile, as shown in a 1-1-st embodiment (120A.1), an input signal may be decorrelated by a decorrelator D, and then the input signal and the decorrelated signal may be input to the upmixing unit 122.

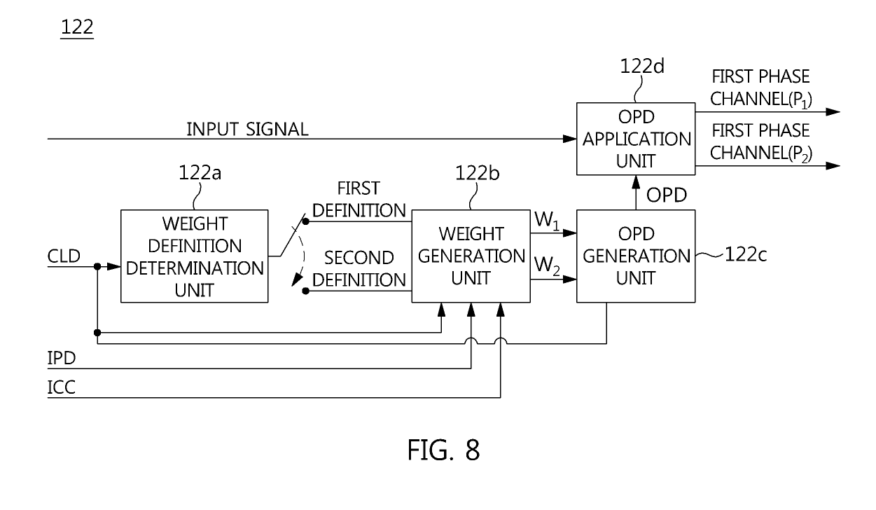

Meanwhile, the upmixing unit 122 may convert the inter-channel phase difference (IPD) into an overall phase difference (OPD), and may apply the OPD to the input signal. Here, the OPD corresponds to a phase difference between the first phase channel and the downmix signal (or a phase difference between the first phase channel and the input signal). A detailed description of the upmixing unit 122 will be made later with reference to FIG. 8.

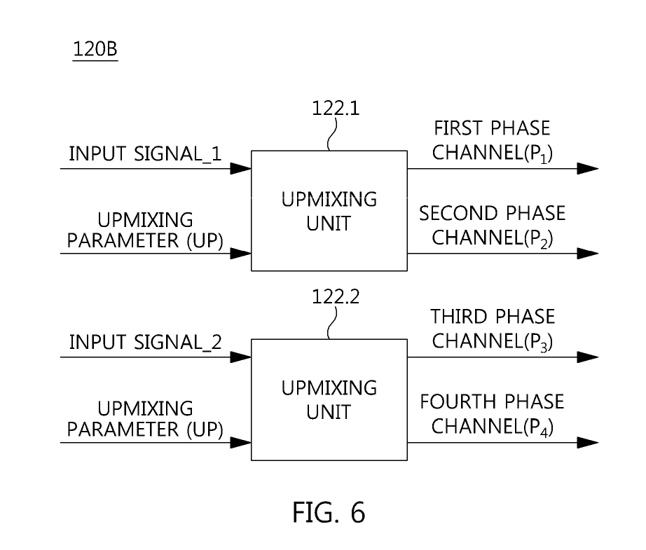

Referring to FIG. 6, the configuration of the output channel generation unit 120B according to a second embodiment may be known. The output channel generation unit 120B includes two upmixing units 122, which are arranged in parallel. A first upmixing unit 122.1 generates a first phase channel P1 and a second phase channel P2 by applying an upmixing parameter UP to an input signal_1, wherein the input signal_1 may be a part of a downmix signal. For example, when the downmix signal is a stereo signal, the input signal_1 may be a left channel signal. A second upmixing unit 122.2 generates a third phase channel P3 and a fourth phase channel P4 by applying an upmixing parameter UP to an input signal_2, wherein the input signal_2 may be a right channel signal when the downmix signal is a stereo signal.

Similarly, detailed configurations of the first upmixing unit 122.1 and the second upmixing unit 122.2 will be described later with reference to FIG. 8.

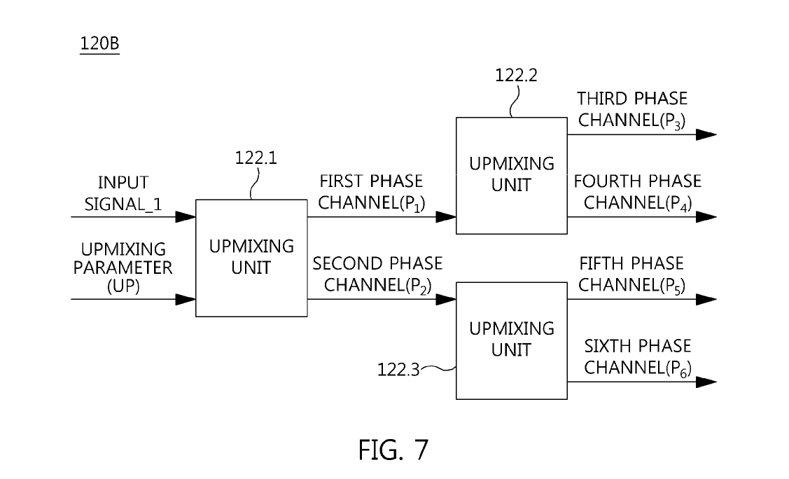

Referring to FIG. 7, the configuration of the output channel generation unit 120C according to a third embodiment may be known. In the output channel generation unit 120C, three upmixing units 122 are hierarchically arranged. A first phase channel P1 and a second phase channel P2 that are the outputs of a first upmixing unit 122.1 are applied as input channels to a second upmixing unit 122.2 and to a third upmixing unit 122.3, respectively. The first upmixing unit 122.1 may perform an operation almost identical to that of the upmixing unit in the first embodiment or the 1-1-st embodiment. The second upmixing unit 122.2 generates a third phase channel P3 and a fourth phase channel P4 by applying the upmixing parameter UP to the first phase channel P1, and the third upmixing unit 122.3 generates a fifth phase channel P5 and a sixth phase channel P6 by applying the upmixing parameter UP to the second phase channel P2.

In addition to the output channel generation units 120A to 120C of the first to third embodiments, a plurality of upmixing units 122 may be combined in parallel and in series and may configure various tree structures, but the present invention is not limited by a specific tree structure.

Below, the detailed configuration of one or more upmixing units 122 included in the embodiments will be described.

FIG. 8 is a detailed configuration diagram showing an embodiment of the upmixing unit 122 of FIGS. 5 to 7. The upmixing unit 122 converts inter-channel phase difference (IPD) information into an overall phase difference (OPD), applies a spatial parameter to the OPD, and then generates two or more channel signals from one or more channels. Referring to FIG. 8, the upmixing unit 122 includes a weight definition determination unit 122a, a weight generation unit 122b, an OPD generation unit 122c, and an OPD application unit 122d.

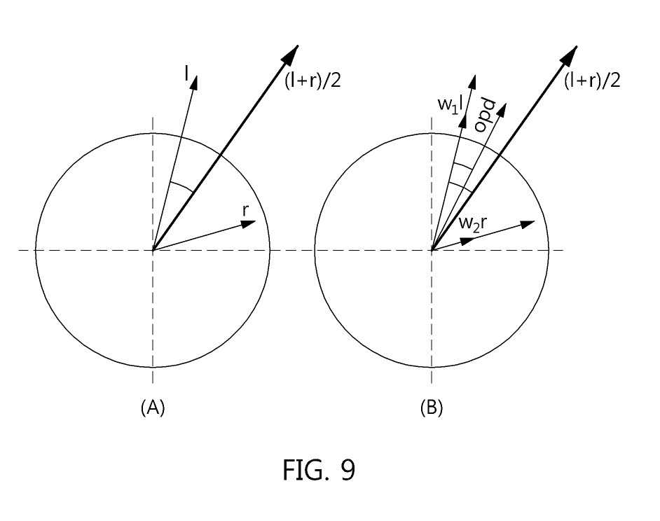

A destructive distortion phenomenon caused by a phase difference will be described with reference to FIG. 9. Referring to FIG. 9, phases between a mono signal and left and right channels are illustrated. FIG. 9 (A) shows a phase difference appearing when a left channel signal and a right channel signal are simply summed to generate a mono signal, as given by the following Equation 1:

$$s = \frac{1}{2} ( l + r ) \qquad [ Equation 1 ]$$

where s denotes a mono signal, l denotes a left channel signal, and r denotes a right channel signal.

As shown in FIG. 9(A), an angle between a vector indicative of the mono signal s and a vector indicative of the left channel signal l is the overall phase difference (OPD). An angle between vectors indicative of the left channel signal l and the right channel signal r may correspond to an inter-channel phase difference (IPD). Since the IPD is less than 90° in FIG. 9(A), an amplification effect for the mono signal (s=½*(l+r)) occurs, and it can be seen that the magnitude of the mono signal s becomes larger than those of the original left and right channel signals. However, when the inter-channel phase difference (IPD) is approximate to 180°, an attenuation effect in which the magnitude of the mono signal s that is the sum of the vectors of the left and right channel signals is approximate to 0 may occur regardless of the magnitudes of the original left and right channel signals.

In order to solve such a problem, definitions for generating a sum signal by applying weights w₁ and w₂ to respective signals are intended to be used, as in an example shown in FIG. 9 (B), instead of the definition in Equation 1. An example of the definitions is given as follows.

s=w₁l+w₂r [Equation 2]

where s denotes a downmix signal (or an input channel signal), l denotes a first phase channel signal (or a left channel signal), r denotes a second phase channel signal (or a right channel signal), w₁ denotes a first weight to be applied to the first phase channel signal, and w₂ denotes a second weight to be applied to the second phase channel signal.

The first weight w₁ and the second weight w₂ are values for selectively increasing the first phase channel l and the second phase channel r. More specifically, the first and second weights are applied so that a higher weight is assigned to a signal having a higher level in consideration of the relative levels of the first phase channel l and the second phase channel r based on a channel level difference (CLD).

In this way, the reason for selectively increasing the first phase channel l and the second phase channel r is that, if a higher weight is applied to a signal having a lower level of the first phase channel l and the second phase channel r, an error may be rather increased compared to the time before the weights are applied. Therefore, a higher weight is applied to a signal having a higher level of the first phase channel and the second phase channel.

Examples of the first weight and the second weight may be represented by the following equation:

$$First definition \text{:} {w}_{1}^{l , m} = ( 2 - \sqrt{{ER}^{l , m}} ) , {w}_{2}^{l , m} = ( \sqrt{{ER}^{l , m}} ) \\ Second definition \text{:} {w}_{1}^{l , m} = ( \sqrt{{ER}^{l , m}} ) , {w}_{2}^{l , m} = ( 2 - \sqrt{{ER}^{l , m}} ) \\ where \\ {ER}^{l , m} = \sqrt{\frac{\begin{matrix}{10}^{\frac{{CLD}^{l , m}}{10}} + 1 + 2 \cdot \\ cos ( {IPD}^{l , m} ) \cdot {ICC}^{l , m} \cdot {10}^{\frac{{CLD}^{l , m}}{20}}\end{matrix}}{{10}^{\frac{{CLD}^{l , m}}{10}} + 1 + 2 \cdot {ICC}^{l , m} \cdot {10}^{\frac{{CLD}^{l , m}}{20}}}} \\ CLD = IID = 10 {log}_{10} \frac{{\vert L \vert}^{2}}{{\vert R \vert}^{2}} \\ {ER}^{l , m} = \sqrt{\frac{\frac{{\vert L \vert}^{2}}{{\vert R \vert}^{2}} + 1 + 2 \cdot cos ( {IPD}^{l , m} ) \cdot {ICC}^{l , m} \cdot \sqrt{\frac{{\vert L \vert}^{2}}{{\vert R \vert}^{2}}}}{\frac{{\vert L \vert}^{2}}{{\vert R \vert}^{2}} + 1 + 2 \cdot {ICC}^{l , m} \cdot \sqrt{\frac{{\vert L \vert}^{2}}{{\vert R \vert}^{2}}}}} = \sqrt{\frac{{\vert L \vert}^{2} + 2 \cdot cos ( {IPD}^{l , m} ) \cdot {ICC}^{l , m} \cdot \vert L \vert \vert R \vert + {\vert R \vert}^{2}}{{\vert L \vert}^{2} + 2 \cdot {ICC}^{l , m} \cdot \vert L \vert \vert R \vert + {\vert R \vert}^{2}}} \qquad [ Equation 3 ]$$

where the first weight is w₁ and the second weight is w₂ in both first and second definitions.

Referring to Equation (3), the definition of weights required to respectively scale the first phase channel and the second phase channel may include a first definition and a second definition, which are selectively applied according to the channel level difference (CLD). In accordance with an embodiment of the present invention, when the channel level value of the first phase channel is greater than (or equal to or greater than) that of the second phase channel, the first definition is applied, whereas when the channel level value of the first phase channel is less than or equal to (or less than) that of the second phase channel, the second definition may be applied. That is, when CLD defined in the above equation is greater than (or equal to or greater than) 0, the first definition is applied, whereas when CLD is less than or equal to (or less than) 0, the second definition may be applied. Meanwhile, in accordance with another embodiment of the present invention, when the channel level value of the first phase channel is greater than a preset value, the first definition may be applied, whereas when the channel level value of the first phase channel is less than or equal to the present value, the second definition may be applied.

Based on the above-described definitions, the detailed configuration of the upmixing unit 122 shown in FIG. 8 will be described below.

The weight definition determination unit 122a selects a definition for determining the first weight w₁ of the first phase channel P1 and the second weight w₂ of the second phase channel P2 based on a channel level difference (CLD) among the spatial parameters of the upmixing parameter UP. More specifically, the channel level difference (CLD) denotes a difference between the levels of the first phase channel and the second phase channel. Therefore, if the CLD is taken into consideration, which one of signals of the first and second phase channels has a higher level may be determined. If the level value of the first phase channel is higher, the weight definition determination unit 122a may select the first definition so that the value of the first weight w₁ is higher than that of the second weight w₂. In contrast, when the energy of the second phase channel is higher, the weight definition determination unit 122a may select the second definition so that the value of the second weight w₂ is higher than that of the first weight w₁.

When the weight definition determination unit 122a selects the first definition, the weight generation unit 122b may calculate a first weight and a second weight depending on the first definition. That is, depending on the first definition of Equation 3, the first weight and the second weight may be calculated. Meanwhile, when the weight definition determination unit 122a selects the second definition, the weight generation unit 122b may calculate a first weight and a second weight depending on the second definition. That is, depending on the second definition of Equation 3, the first weight and the second weight may be calculated. As shown in Equation 3, upon calculating the first weight and the second weight, a channel level difference (CLD), an inter-channel correlation (ICC), and an inter-channel phase difference (IPD) may be used.

When the first and second weights are calculated depending on the first definition, the value of the first weight may be increased as the value of IPD is approximate to 180°. In contrast, when the first and second weights are calculated depending on the second definition, the value of the second weight may be increased as the value of IPD is approximate to 180°.

As described above, the first definition and the second definition are selectively applied depending on the value of CLD, so that a higher weight is applied to a channel having a higher level value of the first phase channel and the second phase channel. In accordance with the embodiment of the present invention, as the value of IPD is approximate to 180°, the value of a weight corresponding to a signal having a higher level value of the first phase channel and the second phase channel may be set to a high value.

In this way, when the first and the second weight are generated by the weight generation unit 122b, the OPD generation unit 122c converts the IPD into an OPD based on the first weight and the second weight. Once the first weight and the second weight are determined, a relationship between the downmix signal and the first phase channel signal is determined based on Equation 2. Then, since the OPD is a phase difference between the downmix signal and the first phase channel, the IPD may be converted into the OPD.

More specifically, an example of a relational expression between the IPD and the OPD is given by the following equation:

$${OPD}_{left}^{l , m} = arctan ( \frac{{c}_{2}^{l , m} sin ( {IPD}^{l , m} )}{{c}_{1}^{l , m} + {c}_{2}^{l , m} cos ( {IPD}^{l , m} )} \\ where \\ {c}_{1}^{l , m} = \sqrt{\frac{{10}^{\frac{{CLD}^{l , m}}{10}}}{1 + {10}^{\frac{{CLD}^{l , m}}{10}}}} , {c}_{2}^{l , m} = \sqrt{\frac{1}{1 + {10}^{\frac{{CLD}^{l , m}}{10}}}} \qquad [ Equation 4 ]$$

According to Equation 4, a CLD as well as the IPD may be additionally used to calculate the OPD.

Then, the OPD application unit 122d generates a first phase channel P1 and a second phase channel P2 from an input signal (or a downmix signal) based on the OPD. Since two channels are generated by applying the OPD to one signal, an upmixing procedure for increasing the number of channels is performed.

Meanwhile, in accordance with another embodiment of the present invention, instead of determining the definition of the first weight and the second weight as described above with reference to Equation 3, the definition of a relationship between a sum signal s (downmix signal) and phase channels may be determined as follows:

first sum:s=w₁l+w₂r

second sum:s=w₂l+w₁r

where

w₁^{l,m}=(2−\sqrt{ER^{l,m}}),w₂^{l,m}=\sqrt{ER^{l,m}} [Equation 5]

That is, according to the embodiment of Equation 5, although the definitions of a first weight w₁ and a second weight w₂ are identical to those of Equation 3, any one of a first sum and a second sum may be determined to be the sum signal s according to the CLD. According to an embodiment of the present invention, when the channel level value of the first phase channel l is greater than (or equal to or greater than) that of the second phase channel r, the first sum may be determined to be the sum signal s, whereas when the channel level value of the first phase channel l is less than or equal to (or less than) that of the second phase channel r, the second sum may be determined to be the sum signal s. Meanwhile, in accordance with another embodiment of the present invention, when the channel level value of the first phase channel l is greater than a preset value, the first sum is determined to be the sum signal s, whereas when the channel level value of the first phase channel l is less than or equal to the preset value, the second sum may be determined to be the sum signal s. Therefore, even in the embodiment of Equation 5, when the level value of the first phase channel is greater than that of the second phase channel, a higher weight may be applied to the first phase channel, whereas when the level value of the second phase channel is greater than that of the first phase channel, a higher weight may be applied to the second phase channel.

A method in which the upmixing unit 122 according to the present invention generates the first phase channel and the second phase channel based on the determined sum signal s has been described above. That is, the upmixing unit 122 may generate overall phase difference (OPD) information based on the sum definition determined based on Equation 5 and the first and second weights w₁ and w₂. Further, the upmixing unit 122 may generate the first phase channel and the second phase channel from the downmix signal s using the OPD, thus performing upmixing.

In accordance with the embodiments of the present invention, when the upmixing unit generates an OPD required to increase the number of channels, destructive interference effect occurring when a phase difference between channels is approximate to 180° may be reduced. In addition, a distortion phenomenon occurring when a higher weight is applied to a signal having a low channel level of a first phase channel and a second phase channel may be decreased.

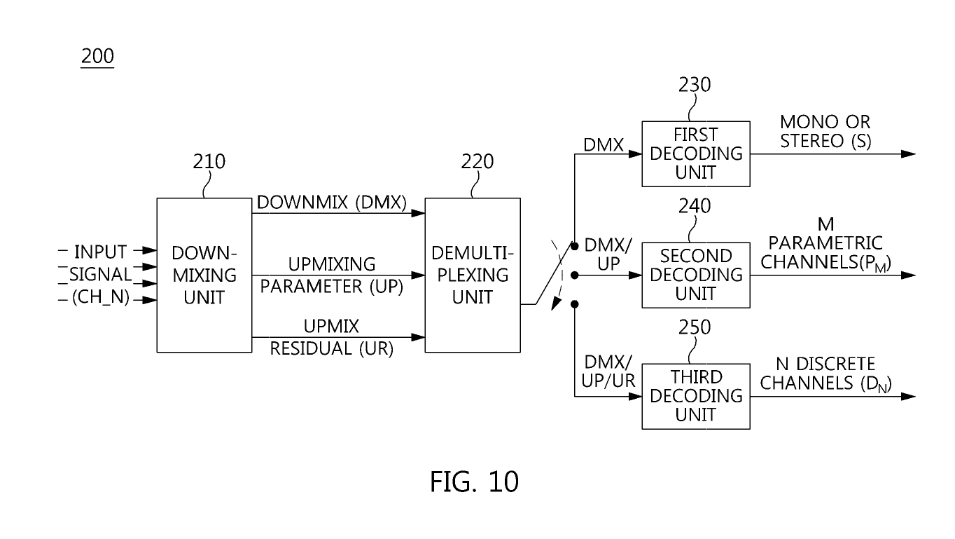

FIG. 10 is a diagram showing the configuration of an encoder and a decoder according to another embodiment of the present invention. FIG. 10 illustrates a structure for scalable coding when speaker setup of the decoder is differently implemented.

An encoder includes a downmixing unit 210, and a decoder includes one or more of first to third decoding units 230 to 250 and a demultiplexing unit 220.

The downmixing unit 210 generates a downmix signal DMX by downmixing an input signal CH_N corresponding to a multichannel signal. In this procedure, one or more of an upmixing parameter UP and an upmix residual signal UR are generated. Then, the downmix signal DMX and the upmixing parameter UP (and the upmix residual signal UR) are multiplexed, and thus one or more bitstreams are generated and transmitted to the decoder.

Here, the upmixing parameter UP, which is a parameter required to upmix one or more channels into two or more channels, may include a spatial parameter, an inter-channel phase difference (IPD), etc., as described above with reference to the embodiment of the present invention.

Further, the upmix residual signal UR corresponds to a residual signal that is a difference between the input signal CH_N, which is the original signal, and a reconstructed signal. Here, the reconstructed signal may be either an upmix signal obtained by applying the upmixing parameter UP to the downmix signal DMX or a signal obtained by encoding a channel, which is not downmixed by the downmixing unit 210, in a discrete coding manner.

The demultiplexing unit 220 of the decoder may extract the downmix signal DMX and the upmixing parameter UP from one or more bitstreams and may further extract the upmix residual signal UR.

The decoder may selectively include one (or one or more) of the first decoding unit 230 to the third decoding unit 250 according to the speaker setup environment. The setup environment of loud speakers may be various depending on the type of device (smart phone, stereo TV, 5.1 ch home theater, 22.2 ch home theater, etc.). In spite of various environments, unless bitstreams and decoders for generating a multichannel signal, such as a 22.2-ch signal, are selective, all of signals corresponding to 22.2 channels are reconstructed and thereafter must be downmixed depending on a speaker play environment. In this case, not only a high computational load required for reconstruction and downmixing, but also a delay may be caused.

However, in accordance with another embodiment of the present invention, the decoder selectively includes one (or one or more) of first to third decoding units depending on the setup environment of each device, thus overcoming the above-described disadvantage.

The first decoding unit 230 is a component for decoding only a downmix signal DMX, and does not accompany an increase in the number of channels. That is, the first decoding unit 230 outputs a mono-channel signal when a downmix signal is a mono signal, and outputs a stereo signal when the downmix signal is a stereo signal. The first decoding unit 230 may be suitable for a device, a smart phone, or TV that is equipped with a headphone in which the number of speaker channels is one or two.

Meanwhile, the second decoding unit 240 receives the downmix signal DMX and the upmixing parameter UP, and generates M parametric channels (PM). The second decoding unit 240 increases the number of output channels compared to the first decoding unit 230. However, when the upmixing parameter UP includes only parameters corresponding to upmixing into a total of M channels, the second decoding unit 240 may output M channel signals, the number of which does not reach the number N of original channels. For example, when the original signal, which is the input signal of the encoder, is a 22.2-channel signal, M channels may be 5.1 channels, 7.1 channels, etc.

The third decoding unit 250 receives not only a downmix signal DMX and an upmixing parameter UP, but also an upmix residual signal UR. Unlike the second decoding unit 240 that generates M parametric channels, the third decoding unit 250 additionally applies the upmix residual signal UR in addition to the parametric channels, thus outputting reconstructed signals for N channels.

Each device selectively includes one or more of first to third decoding units, and selectively parses an upmixing parameter UP and an upmix residual signal UR from the bitstreams, so that signals suitable for each speaker setup environment are immediately generated, thus reducing complexity and a computational load.

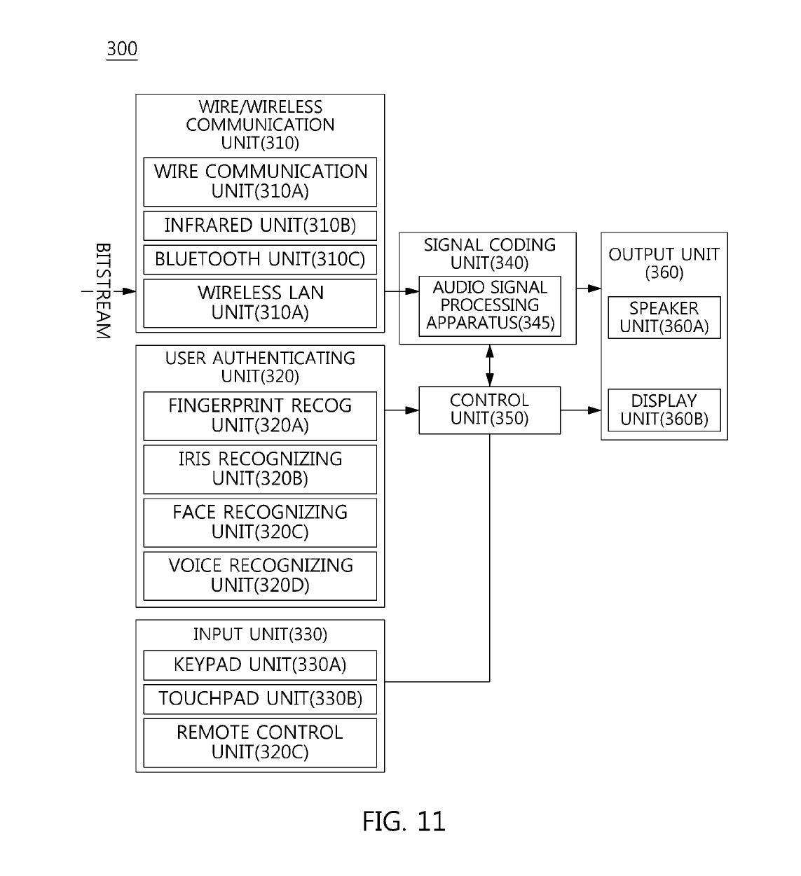

FIG. 11 is a diagram showing a relationship between products in which the audio signal processing device according to an embodiment of the present invention is implemented. Referring to FIG. 11, a wired/wireless communication unit 310 receives bitstreams in a wired/wireless communication manner. More specifically, the wired/wireless communication unit 310 may include one or more of a wired communication unit 310A, an infrared communication unit 310B, a Bluetooth unit 310C, and a wireless Local Area Network (LAN) communication unit 310D.

A user authentication unit 320 receives user information and authenticates a user, and may include one or more of a fingerprint recognizing unit 320A, an iris recognizing unit 320B, a face recognizing unit 320C, and a voice recognizing unit 320D, which respectively receive fingerprint information, iris information, face contour information, and voice information, convert the information into user information, and determine whether the user information matches previously registered user data, thus performing user authentication.

An input unit 330 is an input device for allowing the user to input various types of commands, and may include, but is not limited to, one or more of a keypad unit 330A, a touch pad unit 330B, and a remote control unit 330C.

A signal coding unit 340 performs encoding or decoding on audio signals and/or video signals received through the wired/wireless communication unit 310, and outputs audio signals in a time domain. The signal coding unit 340 may include an audio signal processing device 345. In this case, the audio signal processing device 345 corresponds to the above-described embodiments (the decoder 100 according to an embodiment and the encoder/decoder 200 according to another embodiment), and such an audio signal processing device 345 and the signal coding unit 340 including the device may be implemented using one or more processors.

A control unit 350 receives input signals from input devices and controls all processes of the signal coding unit 340 and an output unit 360. The output unit 360 is a component for outputting the output signals generated by the signal coding unit 340, and may include a speaker unit 360A and a display unit 360B. When the output signals are audio signals, they are output through the speaker unit, whereas when the output signals are video signals, they are output via the display unit.

The audio signal processing method according to the present invention may be produced in a program to be executed on a computer and stored in a computer-readable storage medium. Multimedia data having a data structure according to the present invention may also be stored in a computer-readable storage medium. The computer-readable recording medium includes all types of storage devices readable by a computer system. Examples of a computer-readable storage medium include Read Only Memory (ROM), Random Access Memory (RAM), Compact Disc ROM (CD-ROM), magnetic tape, a floppy disc, an optical data storage device, etc., and may include the implementation of the form of a carrier wave (for example, via transmission over the Internet). Further, the bitstreams generated by the encoding method may be stored in the computer-readable medium or may be transmitted over a wired/wireless communication network.

As described above, although the present invention has been described with reference to limited embodiments and drawings, it is apparent that the present invention is not limited to such embodiments and drawings, and the present invention may be changed and modified in various manners by those skilled in the art to which the present invention pertains without departing from the technical spirit of the present invention and equivalents of the accompanying claims.

### MODE FOR INVENTION

As described above, related contents in the best mode for practicing the present invention have been described.

### INDUSTRIAL APPLICABILITY

The present invention may be applied to the encoding and decoding of audio signals.

1. An audio signal processing method, comprising:
receiving a downmix signal;
receiving inter-channel phase difference (IPD) information corresponding to a phase difference between a first phase channel and a second phase channel;
receiving a channel level difference (CLD) corresponding to a level difference between the first phase channel and the second phase channel;
determining a definition of a first weight to be applied to the first phase channel and a second weight to be applied to the second phase channel, based on the CLD;
calculating the first weight and the second weight using the determined definition and the IPD; and
generating overall phase difference (OPD) information corresponding to a phase difference between the first phase channel and the downmix signal, based on the first weight and the second weight.

2. The audio signal processing method of claim 1, further comprising generating the first phase channel and the second phase channel using the overall phase difference (OPD) information and the downmix signal.

3. The audio signal processing method of claim 1, wherein:
the definition includes a first definition in which the first weight is equal to or greater than the second weight and a second definition in which the first weight is less than or equal to the second weight, and
the determining is configured, based on the CLD, to:
select the first definition when a level value of the first phase channel is greater than that of the second phase channel, and
select the second definition when the level value of the second phase channel is greater than that of the first phase channel.

4. An audio signal processing device, comprising:
a demultiplexing unit for receiving a downmix signal, receiving inter-channel phase difference (IPD) information corresponding to a phase difference between a first phase channel and a second phase channel, and receiving a channel level difference (CLD) corresponding to a level difference between the first phase channel and the second phase channel;
a weight definition determination unit for determining a definition of a first weight to be applied to the first phase channel and a second weight to be applied to the second phase channel, based on the CLD;
a weight generation unit for calculating the first weight and the second weight using the determined definition and the IPD; and
an overall phase difference (OPD) generation unit for generating OPD information corresponding to a phase difference between the first phase channel and the downmix signal, based on the first weight and the second weight.
